(19) United States
(12) Patent Application Publication
(10) Pub. No.: US 2002/0011915 A1
(43) Pub. Date: Jan. 31, 2002

(54) Thermal Protector

(76) Inventors: MASAHIKO NIINO, NAGOYA (JP); KAZUO ITOH, NAGOYA (JP)

Correspondence Address: Pillsbury Madison & Sutro, Intellectual Property Group, 1100 New York Avenue Ninth Floor, Washington, DC, 20005, US

(21) Appl. No.: 08/837,909

(22) Filed: Apr. 11, 1997

(51) Int. Cl. H01H 71/16

(52) U.S. Cl. 337/53

(57) ABSTRACT

The invention provides a thermal protector comprising an enclosure provided with a cylinder case having one open end and a cover for closing the open end and for fitting on the surface of a protected body, a protector section comprising two fixed terminal plates having fixed contacts respectively and secured on the bottom of the cylinder case, an adjusting screw provided on the bottom of the cylinder case, and the dished main bimetal provided with movable contacts facing to the fixed contacts for switching operation, and pressed and supported onto the head of the adjusting screw by a spring, and a heater wire provided near the main bimetal and connected between the one fixed terminal plate and the heater terminal, and a thermostat section having the bimetal which is disposed nearest to the cover at the position parallel to the surface of the protected body, wherein the protector section and the thermostat section are disposed on the bottom side and on the cover side of the cylinder case respectively and connected in series. The protector section is operated in response to over current of the load motor and the thermostat section is operated in response to abnormal temperature rising when only the temperature rises, thus the protector ensures the protection.

### BACKGROUND OF THE INVENTION

This invention relates to a thermal protector suitable for protecting hermetic type compressors of electric appliances such as air conditioners and refrigerators.

For example, an in-room unit and an out-room unit of a separate type air conditioner are connected by way of tubing, and if refrigerant leaks due to failure construction work or a fan motor malfunction due to some restriction, the compressor of the air conditioner over-heats. In such case, the conventional protector, which is actuated in response mainly to current, can not protect the compressor because the current of the motor does not increase from no-load current.

Conventionally to protect the compressor, a compressor and a motor are combined, and the combined compressor and motor are contained in a hermetic dome, and a hermetic type protector are provided to detect directly the temperature. However, such hermetic type protector is expensive, and if the hermetic type protector is damaged, it is required to replace the compressor though the compressor is not damaged. Alternatively, a protector responsive to a current and a protector responsive to only the temperature are both installed, however this method requires a large space for installation, much man-hour for assembling, and inconvenient work for maintenance.

The inventors of the present invention proposed a thermal protector, which is installed outside a compressor dome, comprising the main protector P comprising the main dished bimetal B and a temperature switch TH disposed integratedly (Japanese Published Unexamined Utility Model Application No. Hei 1-79240 and Japanese Published Unexamined Patent Application No. Hei 7-262895). These proposals are described hereinunder.

The first conventional example is shown in FIG. 18. In the figure, FIG. 18A is a partially cut-away front view, FIG. 18B is a cross-sectional view along the line A-A′ in FIG. 18A, and FIG. 18C is an electric circuit diagram. A thermostat TH1 which is open normally and is closed when the temperature rises to a prescribed temperature and a resistor R1 which is supplied a current by way of the thermostat TH1 are provided near the main bimetal B of the main protector P, and a series circuit of the thermostat TH1 and the resistor R1 is connected to a load motor M in parallel.

In other words, the main protector P is connected directly to the power source E through the terminal a of the main bimetal B at the one end and connected to the motor M through the terminal b of the main bimetal B at the other end, the resistor R1 is connected to the output terminal b of the main bimetal B at one end and connected to the thermostat TH1 through a lead wire c at other end, and the other end of the thermostat TH1 is connected to the other phase of the power source through a lead d.

When the motor M is over loaded or the rotor is locked, the main bimetal B is revered and actuated to cut-off the circuit like a usual protector, and when only the temperature rises, the thermostat TH1 is closed to supply a current to the resistor R1 for heating, and the main bimetal B is reversed and actuated to cut-off the circuit.

Next, the second conventional example is shown in FIG. 19. In the figure, FIG. 19A is a plan view, FIG. 19B is a front view, FIG. 19C is a cross-sectional view along the line A-A′ in FIG. 19A, and FIG. 19D is an electric circuit diagram. A thermostat TH2 which is normally closed and a main protector P are connected to a load motor M in series. In the main protector P, a heater wire R2 provided near the main bimetal B heats always the bimetal B, and when only the temperature rises, the thermostat TH2 opens to prevent the motor from burning. The power source is connected to the motor M through both terminals a and b of the bimetal B of the main protector P, the heater wire R2, and both terminals (lead wire) c and d of the thermostat TH2, therefore all these components have the same phase as the power source. The insulation distance of the heater wire R2 to the main bimetal B and respective terminals may be short in comparison with the above-mentioned first conventional example. Therefore, the material, wire diameter, wire length, and configuration of the wire such as foldedtype or coiled type may be selected with less restriction depending on the motor current. The main bimetal B is heated not only by self-heating due to motor current but also by heating from the heater wire R2, thereby this method is applicable to a protector with small motor current.

However, the above-mentioned first conventional example is applicable only to a protector with large motor current and is not applicable to a protector with small motor current because the main bimetal B is operated usually only by way of self-heating due to motor current. The power source voltage is applied to the resistor R1 as it is because the one end of the thermostat TH1 is connected to the phase of the power source opposite to that of the main bimetal B, the strict selection is required for selecting the resistor and a long insulation distance is necessary for parts (thermostat TH1 and c side of the resistor R1) involved in the other phase. In view of this point, the thermostat THl should be contained in an independent housing and has lead wires.

Next, the above-mentioned second conventional example is applicable to a protector with small motor current because the main bimetal B is heated not only by self-heating due to motor current but also by the heater wire R2. However, the thermostat TH2 has a housing separately from that of the main protector P as shown in FIG. 19, the speed of thermal conduction is slow, the whole required space is inevitably large, and this method is disadvantageous in cost and maintenance.

If the motor of the compressor is locked, the main protector is actuated to open the contact in response to the excessive current. Afterward, when the temperature is lowered, the main protector resumes to close the circuit and a current is supplied again, and this operation is repeated. Because the main protector is mounted on the outside of the compressor dome, the surrounding temperature is low, and the reset time is short, and results in much frequent switching, the contact is switched very frequently. Therefore, the service life is short, as a matter of fact, some times the contact points are welded and become impossible to open the circuit and can causes a danger. Because of such disadvantage, the protector can not satisfy the UL standard (in U.S.A.) which requires, for example, 18 day protection against the locked rotor of a motor.

When the surrounding temperature is low, the main protector is involved in long operation time inherently, on the other hand, the reset time is short, therefore the average duty ratio (duty ratio=operating time/(operating time+reset time)) increases, and the risk of burning increases significantly.

To prevent this risk, it is required that the thermostat detects the temperature rise of the compressor motor as soon as possible and it is required that the thermostat is actuated in response to the temperature rise. The main protector responds as soon as possible to the current increase and trips to open the circuit, and after the operation, the heat is not dissipated to the outside to maintain the protector in a high temperature environment for long time, and the reset time is extended longer to lower the above-mentioned duty ratio.

### SUMMARY OF THE INVENTION

The present invention is accomplished to solve the above-mentioned problems, it is an object of the present invention to provides a thermal protector which is capable of protecting surely a motor in the case that only the temperature rises without current increase of the motor.

It is another object of the present invention to provide a thermal protector which is capable of protecting surely a motor under severe condition that only the temperature rises without current increase of the motor due to fluctuation in source voltage or lowering in environmental temperature.

To solve the above-mentioned problems, the thermal protector of the present invention is provided with an enclosure comprising a cylinder case having one open end and a cover for closing the open end and fitting on the surface of a protected body, a protector section in which the main bimetal is connected in series to a heater wire provided near the main bimetal, and a thermostat section which normally is closed and occasionally is opened when the temperature rises to a prescribed temperature, wherein the protector section and the thermostat section are disposed on the bottom side of the cylinder case and on the cover side in the enclosure respectively, and the protector section and the thermostat section are connected in series.

The detailed structure is described hereinunder, that is, the protector section is provided with two fixed terminal plates having a fixed contact respectively and secured on the bottom of the cylinder case, an adjusting screw provided on the bottom of the cylinder case, and movable contacts facing to the fixed contacts for open-close operation, and comprises the main bimetal pushed and supported onto the head of the adjusting screw by a spring, and a heater wire provided near the main bimetal and connected between the one fixed terminal plate and the heater terminal, and the bimetal of the thermostat section is disposed nearest to the cover at the position parallel to the surface of the protected body, and thus the above-mentioned problems are solved.

The adjusting spring presses and holds the disc main bimetal of the protector section onto the head of the adjusting screw which is bonded to the screw section with thermally melt-able metal, thus in case that the temperature happens to rise abnormally due to any one of the above-mentioned causes, the thermal protector shuts down the circuit (referred to as fail safe operation hereinafter).

To solve the above-mentioned problems, the thermal protector of the present invention is provided with; a protector section having a cylinder case with an open end,

a cover fitting on the surface of the protected body and for closing the open end of the case,

a pair of fixed terminal plates having a fixed contact and secured on the bottom of the case, a main bimetal having a movable contact facing to the fixed contact for open-close operation onto the fixed contact supported by the case, and a heater wire which is disposed near the main bimetal and connected between the one fixed terminal plate, and

a thermostat section having a pair of terminal plates which is normally closed and is occasionally opened when the temperature rises to a prescribed temperature, wherein the pair of fixed terminal plates of the protector section and the pair of terminal plates of the thermostat section are guided to the outside from the bottom of the case, and provided at the position orthogonal each other, and

the heater terminal plate of the protector section is connected to the one terminal plate of the thermostat section are connected in the outside to connect the protector section and the thermostat section in series.

The detailed structure is described hereinunder, that is, the heater terminal plate of the protector section is connected to the one terminal plate of the thermostat section by spot welding, this structure is a feature of the present invention.

As described hereinabove, in the thermal protector of the present invention, if a current increases due to overload or locked rotor , the main bimetal of the protector section is actuated to reverse in response to heating by self-heating and by the heater-heating disposed near the main bimetal like the conventional thermal protector, and the movable contact is separated from the fixed contact.

In the case that the over-current protection is difficult with only the conventional main bimetal because the full load current of the motor of a small compressor of an appliance such as small air-conditioner or refrigerator is relatively small, the present invention provides the sufficient over-current protection by selecting arbitrarily the heater wire using the common enclosure with the same required space as the conventional enclosure and common parts regardless of the rated capacity of the motor.

Further, in the case that only the temperature rises to a prescribed temperature due to the leakage of refrigerant, the thermostat, which is normally closed, is opened to shut down the circuit, and the burning of the motor is prevented. The thermostat is attached close to the surface of the protected body, where the temperature detection is required seriously, with interposition of the clamp and cover made of excellent thermal conduction material, though the place is located outside the compressor dome, and on this side thermostat section and the bimetal are disposed near the surface of the protected body in parallel to lead the quick operation responsive to the temperature rising of the inside motor which is the heat source.

The terminal plate of the protector section and the terminal plate of thermostat section are disposed perpendicularly each other on the bottom of the cylinder case, this structure favors the automatic assembling. It is very easy to test electrically the protector section and the thermostat section independently by utilizing the terminal plate of the protector section and the terminal plate of the thermostat section. Further, the protector section is connected easily to the thermostat section in series because the heater terminal plate of the protector section is connected to the one terminal plate of the thermostat section outside.

In the thermal protector of the present invention comprising the protector section and the thermostat section, the protector section and the thermostat section are insulated each other with insulating material, the cover which covers the thermostat section is made at least partially of excellent thermal conduction material such as metals to improve the thermal conduction from the surface of the protected body, for example, the dome in which the compressor motor is accommodated.

In the protector section, the heat generated from the heater is concentrated on the main bimetal for absorbing the heat, and the heat is prevented from dissipation to the outside in order to shorten the duty ratio, after the operation, the temperature lowering speed is decreased to extend the reset time.

Conventionally the heat generated from the heater is transferred to the bimetal and the case where the heat is absorbed, however in this invention, the inside of the case is made in the form of concave mirror or made of white material for effective reflection of the heat, the heat generated from the heater is concentrated effectively on the main bimetal, and the space volume of the protector section is made small, such structures favor the quick response to the temperature change.

To prevent the heat from dissipating to the outside of the protector section, the case wall near the bimetal provides double layers to serve air insulation layer and the terminal plate is made of relatively low thermal conduction material such as iron.

The protector section where the heat should be prevented from dissipating to the outside are insulated thermally from the thermostat section where the heat should be transferred quickly to the outside, and both sections are insulated each other so that arc generated in one section does not affect on the other section when any one of the sections is shut down.

In the thermal protector of the present invention, in case that the current increases abnormally due to overload or locked rotor, the main bimetal of the protector section is reversed in response to self-heating and heating by the heater disposed near the main bimetal, like the conventional one and the movable contact is separated from the fixed contact.

Further, in case that only the temperature rises to a prescribed temperature due to leakage of refrigerant, the thermostat which is normally closed, is opened to shut down the circuit, and the burning damage of the motor is prevented. When, the thermostat is attached close to the surface of the protected body, where the temperature detection is required seriously, with interposition of the cover made of excellent thermal conductive material, though the place is located outside the compressor dome, and on this side thermostat section and the bimetal are disposed near the surface of the protected body in parallel to lead the quick operation responsive to the temperature rising of the inside motor which is the heat source.

Next, in the protector section as described hereinabove, the heat generated from the heater is concentrated on the main bimetal to be heated quickly and operated. Afterwards, the accumulated heat is prevented from dissipating to the outside by the air insulating layer in the double wall, the temperature around the bimetal is maintained high, the reset time is extended, and the duty ratio is suppressed small.

### BRIEF DESCRIPTION OF THE DRAWINGS

FIG. 1 is a set of diagrams for illustrating the first embodiment of a thermal protector of the present invention, wherein FIG. 1A is a central cross-sectional view and FIG. 1B is an electric circuit diagram.

FIG. 2 is a plan view of the embodiment.

FIG. 3 is a left side view of the embodiment.

FIG. 4 is a bottom view of the embodiment.

FIG. 5 is a cross-sectional view along the line B-B′ in FIG. 2.

FIG. 6is a cross-sectional plan view along the line C-C′ in FIG. 1A.

FIG. 7 is a bottom view of FIG. 1A from which the cover and clamp are removed.

FIG. 8 is a set of diagrams, wherein FIG. 8A is a plan view for illustrating the main protector incorporated in the cylinder case, FIG. 8B is the central cross-sectional view of FIG. 8A, FIG. 8C is diagram for describing respective parts of the thermostat before being incorporated, in this figure, the left figure shows the left side view and bottom view of the fixed contact terminal and the right figure shows the right side view and bottom view of the movable contact terminal to which the movable contact plate is secured, FIG. 8D is a cross-sectional view of the thermo bimetal and cover, and FIG. 8E is a cross-sectional view of the protector under the condition that the cover shown in FIG. 8C is incorporated in the cylinder case shown in FIG. 8A, further the thermo bimetal and cover shown in FIG. 8D are incorporated, and the clamp is being fixed.

FIG. 9 is a set of diagrams, wherein FIG. 9A is a partial diagram for describing the above-mentioned embodiment, and FIG. 9B is a partial diagram for describing the modified embodiment.

FIG. 10 is a set of diagrams for illustrating the second embodiment of a thermal protector of the present invention, wherein FIG. 10A is a cross-sectional view along the center line A-A′ in FIG. 11 and FIG. 10B is an electric circuit diagram.

FIG. 11 is a plan view of a thermal protector of the second embodiment.

FIG. 12 is a left side view of the thermal protector of the second embodiment.

FIG. 13 is a cross-sectional view along the line B-B′in FIG. 11.

FIG. 14 is a bottom view of the second embodiment under the condition that the protector is incorporated in the case before the cover and thermostat section are incorporated.

FIG. 15 is a plan view for illustrating the cover and thermostat section in the second embodiment.

FIG. 16 is a set of diagrams for illustrating partial parts of the cover and thermostat secttion in the second embodiment, wherein FIG. 16A is a front view from the arrow D-D′ of the FIG. 16B, FIG. 16B is a bottom view, and FIG. 16C is a side view from the arrow E-E′ of the FIG. 16B.

FIG. 17 is a diagram for illustrating a compressor having a thermal protector.

FIG. 18 is a set of diagrams for describing the first conventional example, wherein FIG. 18A is a partially cutaway front view, FIG. 18B is a cross-sectional view along the line A-A′ in FIG. 18A, and FIG. 18C is an electric circuit diagram.

FIG. 19 is a set of diagrams for describing the second conventional example, wherein FIG. 19A is a plan view, FIG. 19B is a front view, FIG. 19C is a cross-sectional view along the line A-A′ in FIG. 19A, and FIG. 19D is an electric circuit diagram.

### DETAILED DESCRIPTION OF THE PREFERRED EMBODIMENTS

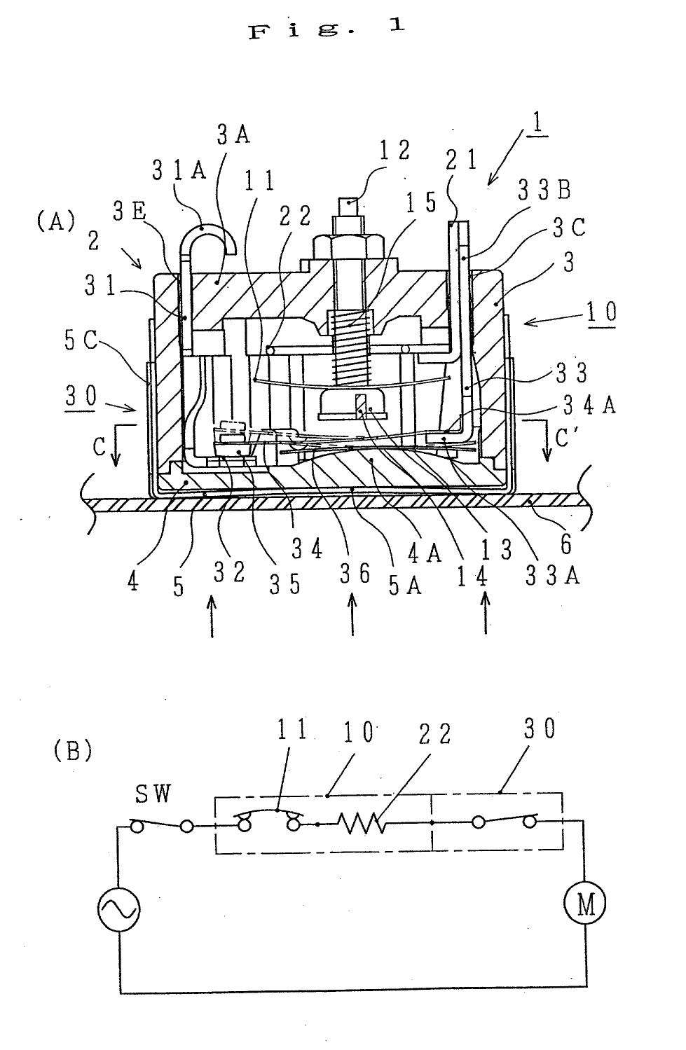

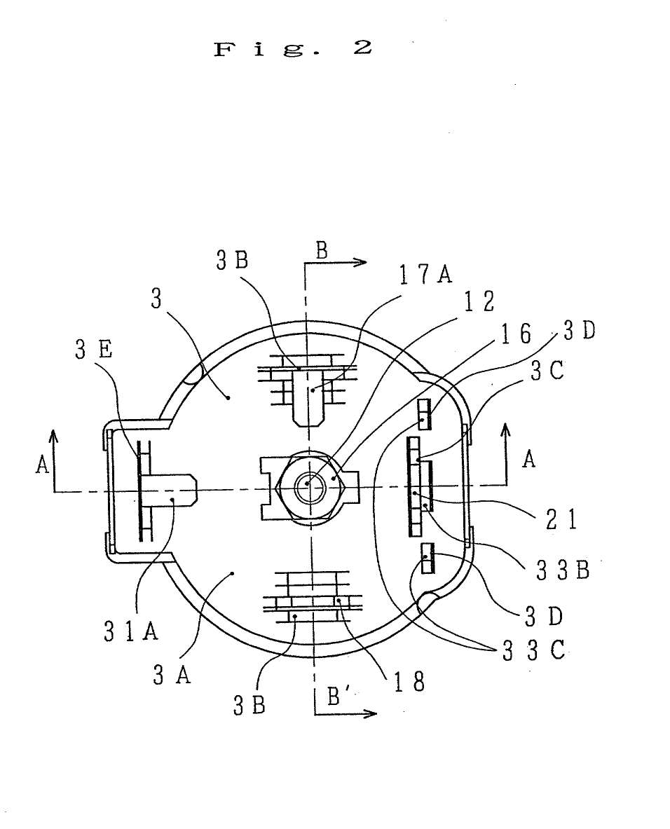

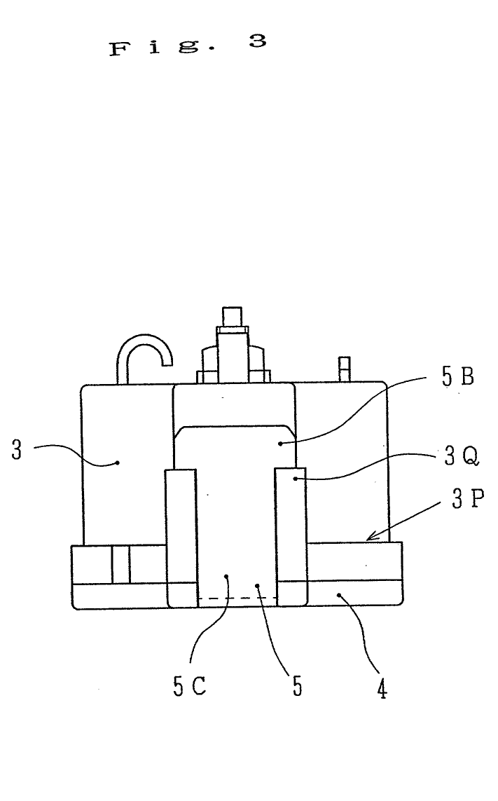

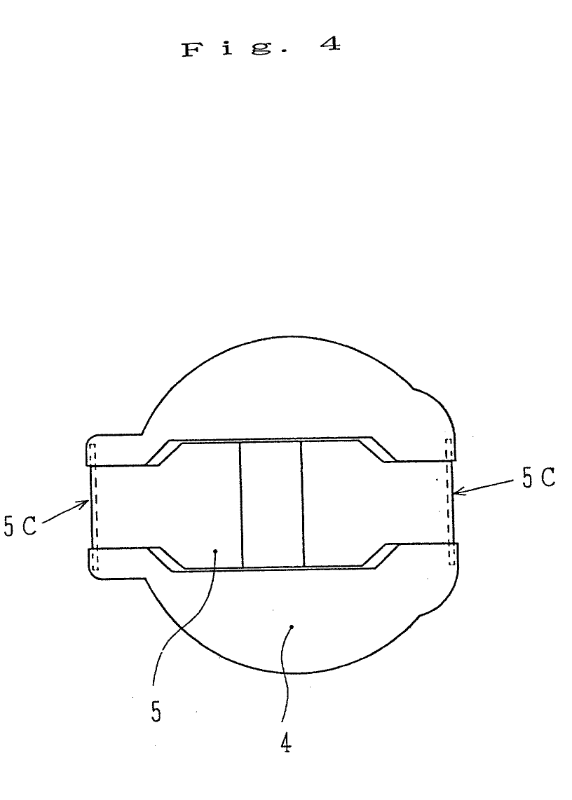

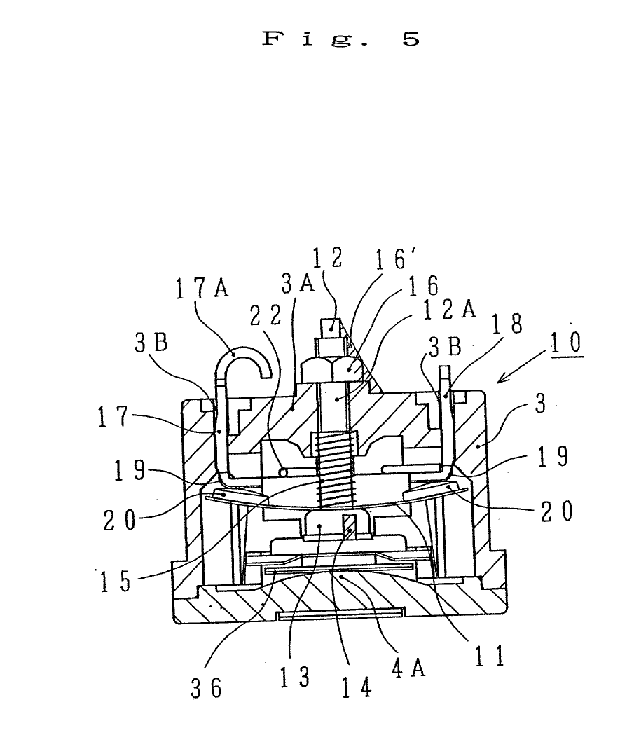

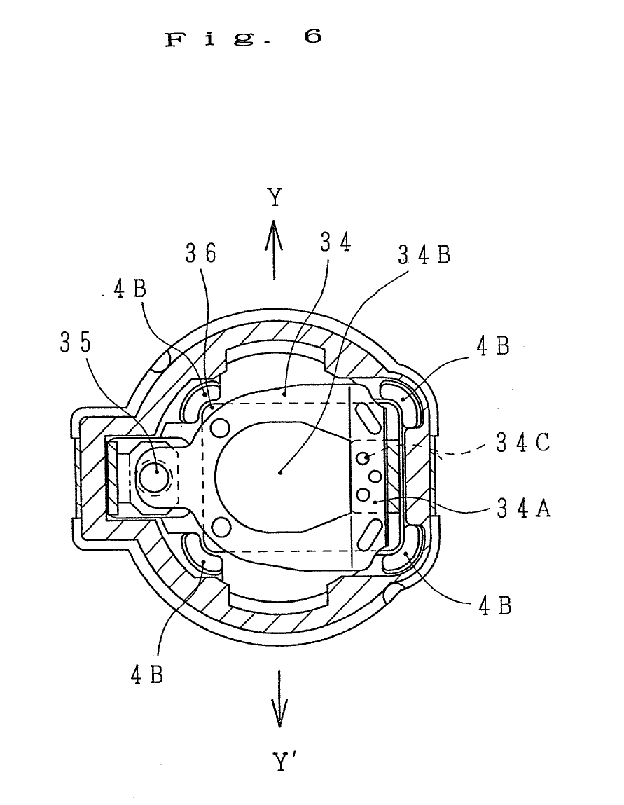

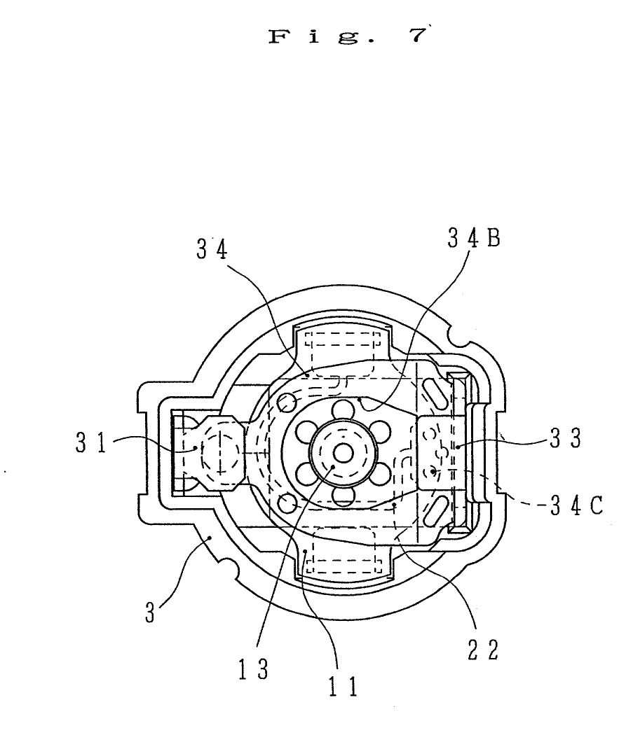

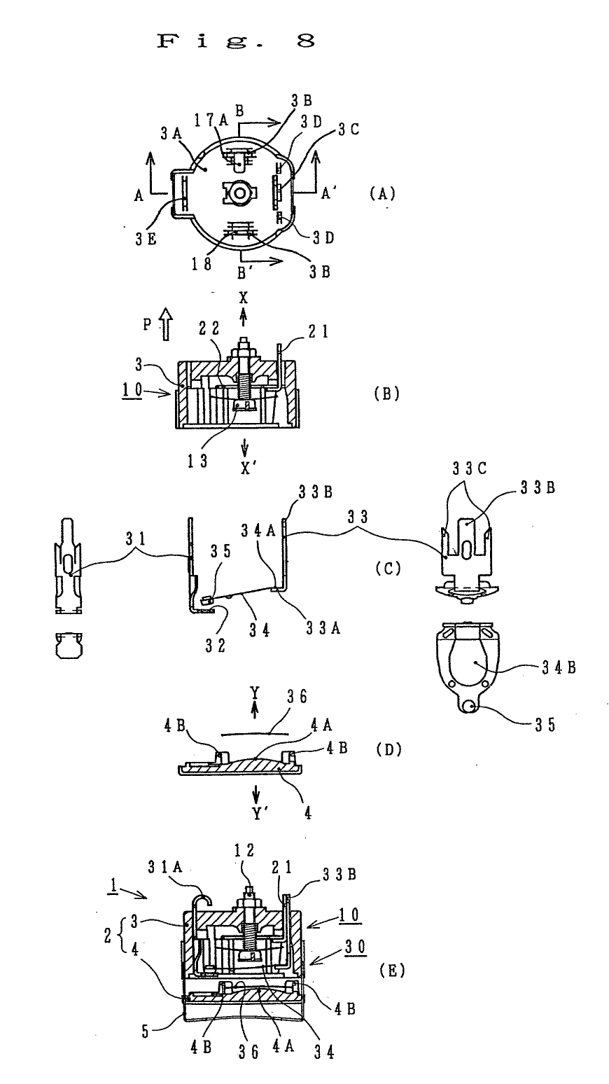

The embodiments of the thermal protector of the present invention is described in detail referring to FIG. 1 to FIG. 9. FIG. 1A is a cross-sectional view along the center line , FIG. 1B is an electric circuit diagram, FIG. 2 is a plan view, FIG. 3 is a left side view, FIG. 4 is a bottom view, FIG. 5 is a cross-sectional view along the line B-B′ in FIG. 2, FIG. 6 is a plan cross-sectional view along the line C-C′ in FIG. 1, FIG. 7 is a bottom view from which the cover 4 and clamp 5 shown in FIG. 1A are removed, FIG. 8 is a diagram for illustrating the method for manufacturing, and FIG. 9A and FIG. 9B are diagrams for partially describing the above-mentioned embodiment and another embodiment respectively.

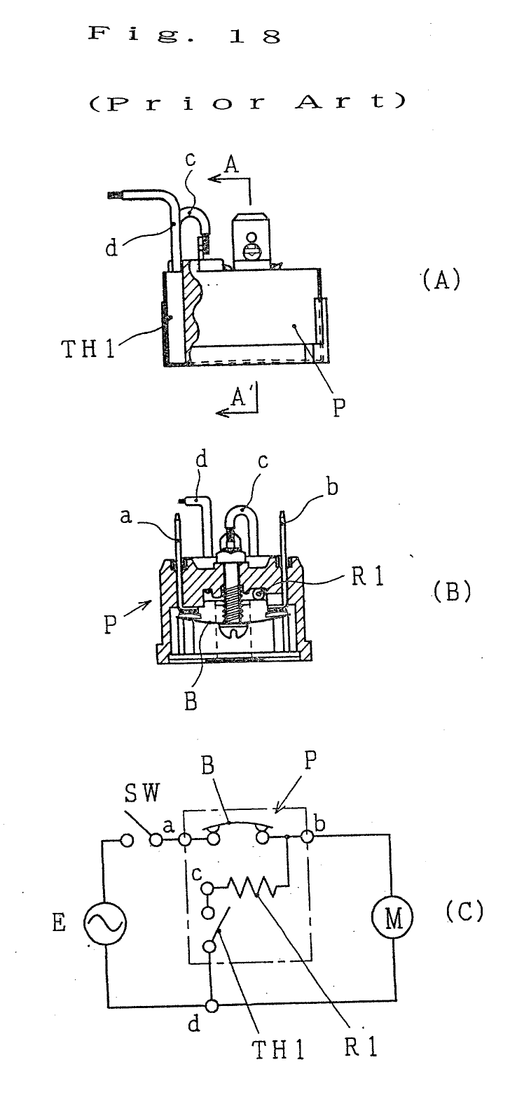

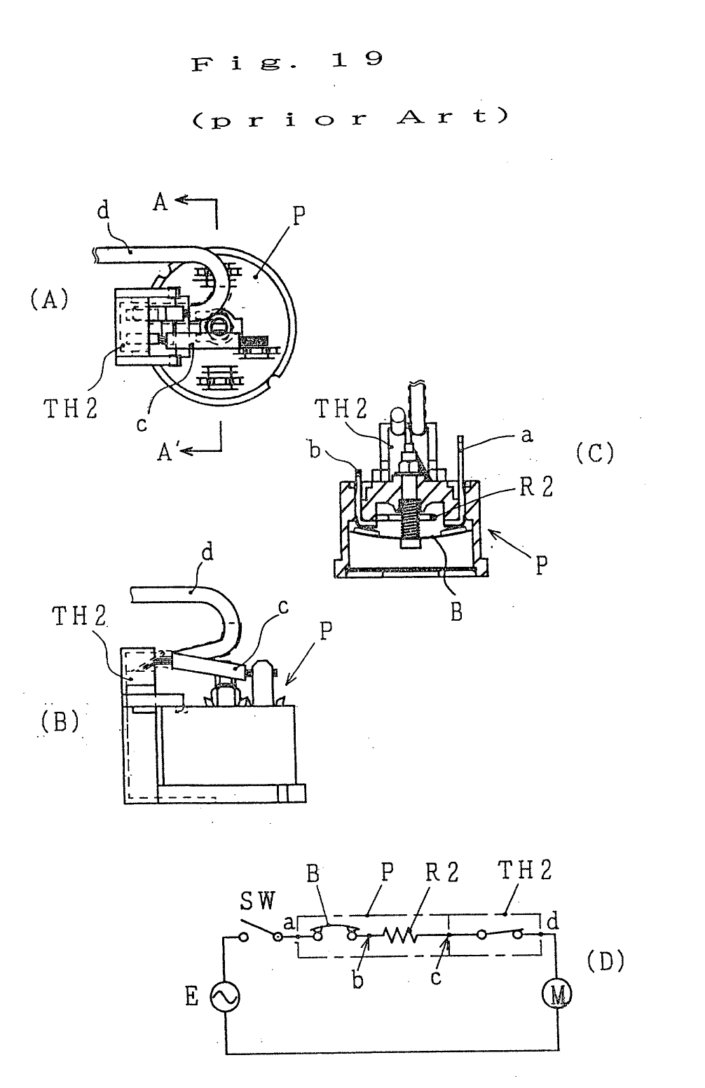

As shown in FIG. 17, the thermal protector 1 of the present invention is attached on the outside face of the dome of a compressor 90, namely the surface 6 where heat flux from the heat source built-in compressor motor M comes most intensely (referred to as the surface of the protected body) The compressor 90 has a power source terminal 94 and terminal covers 96A, 96B. The enclosure 2 consisting of insulator comprises a cylinder case 3 with one open end and a cover 4 for covering the open end ( as shown in FIG. 1

The thermal protector 1 is assembled through steps of incorporating a protector section 10 and then the thermostat section 30 which is normally closed and is opened at a prescribed temperature are incorporated in the inside of the case 3, subsequently fitting of the cover 4, and fixing it with the clamp 5.

The clamp 5 is made of a metal plate having excellent thermal conductivity and some elasticity, and comprises the slightly curved intermediate section 5A, and both sides SC having an ear 5B at the end as shown in FIG. 1, FIG. 3, and FIG. 4, the sides SC are pressed onto the outer side of the cylinder case 3 and ears 5B are engaged with the projection 3Q of the case 3, and the cover 4 is fixed.

Therefore, the protector is attached by pressing it onto the surface of the protected body 6 using a suitable method (in this embodiment, a fixing plate (not shown in the figure) for fixing to the compressor which clips the collar 3P of the enclosure).

Continuously the structure of the protector section 10 is described. FIG. 1A shows a cross-section along the line A-A′ in FIG. 2, and FIG. 5 shows a cross-section along the line B-B′ in FIG. 2. As shown in FIG. 5, in the protector section 10, an adjusting screw 12is provided at the center of the bottom 3A of the cylinder case 3, an adjusting spring 15 maintains the dished main bimetal 11 to press onto the head 13 of the adjusting screw 12. The adjusting screw 12 comprises the screw section 12A and melt-able head 13, the adjusting screw 12 is bondedwith thermally fusible metal 14 such as solder, and after completion of adjusting, the adjusting screw 12 is fixed with a nut 16 and/or lock-paint 16′. The fixed terminal plates 17 and 18 having respectively inlay type fixed contacts 19 and 19 are secured by inserting the leg into the slots 3B and 3B of the bottom 3A of the case 3 followed by crimping both sides. The other outer end 17A of the fixed terminal plate 17 is folded for serving as a terminal for connecting to a lead wire (not shown in the figure) from the power source. The movable contacts 20 and 20 provided on the main bimetal 11 are faced to the fixed contacts 19 and 19, and are in on-off contact with the fixed contacts 19 and 19 respectively. The heater terminal 21 is secured in the slot 3C located at the position distant 90 degrees from the center of the bottom 3A of the case 3 like the fixed terminal plates 17 and 18 (refer to FIG. 2). The heater wire 22 consisting of nichrome wire is disposed facing to the main bimetal 11 so that the main bimetal 11 is heated, both ends of the heater wire 22 are connected to the other fixed terminal plate 18 and heater terminal 21 by spot welding.

In the protector section 10, usually power is supplied from the outer end 17A of the one fixed terminal plate 17 to the heater terminal 21 through the fixed contact 19, movable contact 20, main bimetal 11, movable contact 20, fixed contact 19, the other fixed terminal plate 18, and heater wire 22.

Next, the thermostat section 30 is described. The thermostat section 30 comprises a fixed contact terminal 31 provided with an inlay type fixed contact 32, movable side terminal 33, movable contact plate 34 provided with a thermo movable contact 35 at the free end of the movable contact plate 34, and thermo bimetal 36 as shown in FIG. 1A.

The fixed contact terminal 31 and movable side terminal 33 are fixed at the position (on the line A-A′) distant 90 degrees from the center line B-B′ of the fixed terminal plates 17 and 18 of the protector section 10 on the bottom 3A of the common cylinder case 3 as shown in FIG. 2. The fixed contact terminal 31 is secured by inserting and crimping the leg into the slot 3E like the fixed terminal plates 17 and 18 and the outer end 31A is folded to serve as the output terminal for connecting to the motor M.

In FIG. 1, the bottom bent 33A of the movable side terminal 33 is fixed to the base end of the movable contact plate 34 (for example, by resistance welding at the projection 34C shown in FIG. 7). The center end 33B of the movable side terminal 33 which is an upward tripod as shown in FIG. 8C is moved along the heater terminal 21 of the protector section 10 and inserted into the same slot 3C. Simultaneously, the residual both legs 33C and 33C are inserted into slots 3D and 3D (refer to FIG. 2), and secured by clamping like the terminal 31, afterward, the outer end of the heater terminal 21 is fixed to the center leg 33B of the movable side terminal 33 by spot welding. That is to say, the slot 3C serves as junction to connect the protector section 10.

The movable contact plate 34 is made of elastic meatal plate, provided with a thermo movable contact 35 at the free end of the movable contact plate 34, faced to the fixed contact 32 for contact, and the based end 34A is fixed to the bent 33A of the movable side terminal 33 as shown in FIG.1 and FIG. 8C.

A large opening 34B located at the center of the movable contact plate 34 is expanded over the extension of the center line X-X′ of the protector section 10 (refer to FIG. 8B), the opening 34B serves as the passage of a tool for adjusting the adjusting screw head 13 and also as relief for the operation of fail safe.

Normally, as shown with a solid line in FIG. 1A, thermo bimetal 36, which is upward convex in the figure, is disposed between the movable contact plate 34 and the large convex part 4A having the circular arc cross-section on the center of the cover 4 as shown in FIG. 1(A), and the movable contact plate 34 brings the thermo movable contact 35 on the end thereof in the contact with the thermo fixed contact 32 which is facing to the thermo movable contact 35. When the temperature rises to a prescribed temperature, the thermo bimetal 36 is reversed to the downward convex shape as shown with a broken line in FIG. 1A, the contact 35 and 32 are opened rapidly to shut down a current.

The thermo bimetal 36 of approximate rectangle shape is formed so that the curvature of the thermo bimetal 36 is reversed (from concave to convex) at a prescribed temperature, and as shown in FIG. 8D, the inside surface of the cover 4 (upper side in FIG. 1A) provides an approximately sphrical convex 4A and four convex parts 4B, 4B, 4B, and 4B for guiding the thermo bimetal 36.

That is, the left end (in FIG. 1A) of the thermo bimetal 36 is lifted to push up the movable contact plate 34 utilizing the principle of the lever having the base end at the right end and having the fulcrum at the circular arc convex part 4A of the cover 4, both contacts 35 and 32 are separated to shut down the circuit. The four convex parts 4B, the circular arc convex part 4A, and the thermo bimetal 36 are on the center line Y-Y′, in other words, the bimetal 36 is loosely supported at the right end and free at the left end movably, thereby, the end of the movable contact plate 34 and the thermo movable contact 35 are movable responsively in a wide range, thus this mechanism ensures the smooth and reliable switching operation.

In the thermal protector 1 of the embodiment, when an excess current flows due to overload or locked rotor of the motor M, the main bimetal 11 generates heat, for example, if the temperature increases to 160° C., then the dished main bimetal 11 is reversed to separate the movable contacts 20 and 20 from the fixed contacts 19 and 19, and the current is shut down to protect the motor M.

In the case that only the temperature increases without current increase due to refrigerant leakage, the dish shape of the thermo bimetal 36 which is upward convex in the normal temperature in the FIG. 1A (as shown with a solid line in FIG. 1A) is reversed rapidly at, for example, 120° C., and lifts the movable contact plate 34, and the contacts 35 and 32 are separated (as shown with a broken line in FIG. 1A).

Next, a method for manufacturing of the thermal protector 1 of the embodiment is described mainly referring to FIG. 8. In FIG. 8, FIG. 8A and FIG. 8B show the condition that the main protector section 10 is incorporated in the cylinder case 3, and FIG. 8A is a plan view and FIG. 8B is a cross-sectional view along the center line.

FIG. BC shows respective parts of the thermostat section 30 before assembling, the left side of the figure shows a left side view and bottom view of the fixed contact terminal 31, and the right side of the figure shows the right side view and bottom view of the movable contact plate 34 and the movable side terminal 33 which are bonded together. FIG. 8D is a cross-sectional view of the thermobimetal 36 and cover 4. FIG. 8E is a cross-sectional view of the thermo bimetal 36 and cover 4 incorporated and clamp 5 being clamped.

Though the protector section 10 is incorporated in the same manner as described hereinbefore and the description is omitted, the protector section 10 is inserted into the arrow direction P and incorporated at the bottom of the cylinder case 3. In this condition, the operation performance of the protector section 10 is tested, and adjusted as required. (refer to FIG. 8A and FIG. 8B).

Next, the fixed contact terminal 31 and the movable side terminal 33 with the movable contact plate 39 of the thermostat section 30 are inserted in the same direction (P) and fixed by crimping. Further, the thermo bimetal 36 is inserted with the cover 4, and finally the clamp 5 is fitted and fixed to the cover 4.

The operation performance of the thermostat section 30 is tested, and if, for example, the operation temperature is not within the specified range or malfunctions such as chattering or delayed snap action are found, the clamp 5 is detached from the convex part 3Q of the case 3 utilizing the elastic property of the tip ear 5B. The cover 4 and thermo bimetal 36 are detached, and the end of the fixed contact terminal 31 provided with fixed contact 32 is adjusted or the thermo bimetal 36 is replaced with another one selected from a group of thermo bimetals stratified depending on the performance level, then the desired performance is easily obtained.

The terminals (17A and 18) of the protector section 10 and the terminals (33 and 31) of thermostat section 30 are disposed perpendicularly each other on the bottom 3A of the cylinder case 3, this layout favors the automatic assembling. Further, the protector section 10 and thermostat section 30 can be electrically tested separately even after completion utilizing the terminals 21 and 33 in slot 3C for the junction to connect.

Next, the structure of the head 13 of the adjusting screw 12 is described referring to FIG. 9. FIG. 9A is a crosssectional view along the line B-B′ in FIG. 2. The adjusting screw 12 of the protector section 10 comprises the head 13 and screw 12B, and the head 13 and the screw 12B are bonded with thermally melt-able metal 14. If the main bimetal 11 is fatigue-damaged due to repeated switching or due to the short-circuit at motor M, thereby the movable contact 20 is welded and bonded to the fixed contact 19, then the temperature rises to an abnormal temperature (for example, 220° C.), and causes the thermally melt-able metal 14 to melt, the main bimetal 11 is pushed down by the adjusting spring 15, and the contacts 20 and 19 are shut down. After the temperature decreases and the shape of the main bimetal 11 resumes, the circuit remains still not closed, and the safety is ensured. (the above-mentioned fail safe operation).

The large opening 34B is provided at the center of the movable contact plate 34 of the thermostat section 30, and if the adjusting screw head 13 and the main bimetal 11 are separated, the adjusting screw head 13 falls in the large opening 34B, and does not prevent the operation of the main bimetal 11. Further, these parts are all in the same phase side of the power source, short-circuit will not occur between different phases, thus the fail safe is perfect.

FIG. 9B shows the structure of a modified thermal protector of this embodiment in which the head 23A of the adjusting screw 23 and the screw 23B is formed solidly, this modified thermal protector is used for cases which do not require fail safe. In this case, the circular opening 34B on the movable contact plate 34 of the thermostat section 30 is needless because the head 13 does not fall down, a conventional simple movable contact plate may be used.

As described hereinbefore, in the thermal protector 1 of the first embodiment, the main protector section and the thermostat section are provided in the common case to serve the function of the conventional two elements, and the thermal protector plays two stage role of the protection of over current and the prevention of over heating.

Because the thermostat section is provided near the protected surface, and in detail the bimetal is provided in parallel to the protected surface, the speed of thermal conduction is increased, and the thermostat responses sensitively to the temperature change.

In particular, because the protector section is connected to the thermostat section in series, and all the parts are in the one phase of the power source, if the rated voltage of the load motor is different, the structure of the thermal protector of the present invention does not require the change (in the case of the first conventional example, a resistor of a prescribed rated voltage is required), and though commercial single-phase voltage ranges variously from 100 V to 250 V depending on the country, the thermal protector of the present invention can be used commonly in various countries without any modification.

Because the specific resistivity, size, and shape of the heater wire, which is provided near the main bimetal of the protector section, can be selected un-restrictedly, if the full-load current of the motor is small, the optimal specification is determined depending on the actual condition of loading on the motor, and thus the protection of over current is ensured. Further, if the motor causes short-circuit, the heater wire is fused and the thermal protector is protected as the secondary effect. Also the fail safe using the thermally melt-able metal applied to the adjusting screw provides an attractive effect. Further, in some conventional thermal protectors, the thermostat can be connected to the other phase of the power source, an independent housing is provided and disposed independently from the main protector, and connected to the main protector with lead wires, however in the present invention, the thermostat section has no independent housing and contained in the common case, the structure is advantageous in thermal conduction, space, and cost.

The terminals (17A and 18) of the protector section 10 and the terminals (33B and 31) of thermostat section 30 are disposed perpendicularly each other on the bottom 3A of the cylinder case 3, this structure favors the automatic assembling, and further, the protector section 10 and thermostat section 30 can be subjected easily to electric test separately after completion of the assembling by utilizing the terminals 21 and 33 in the slot 3C for junction to connect.

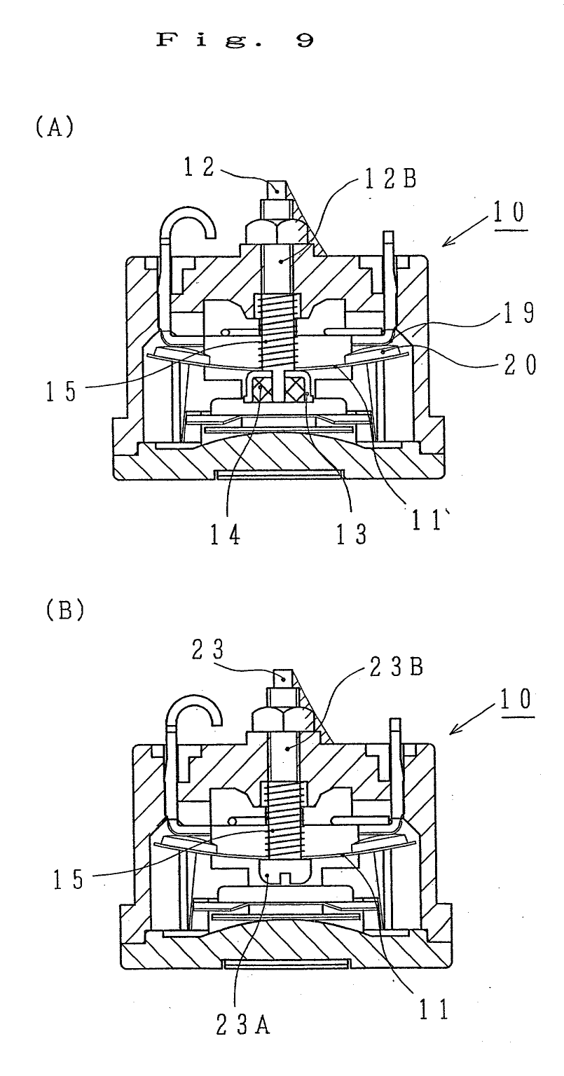

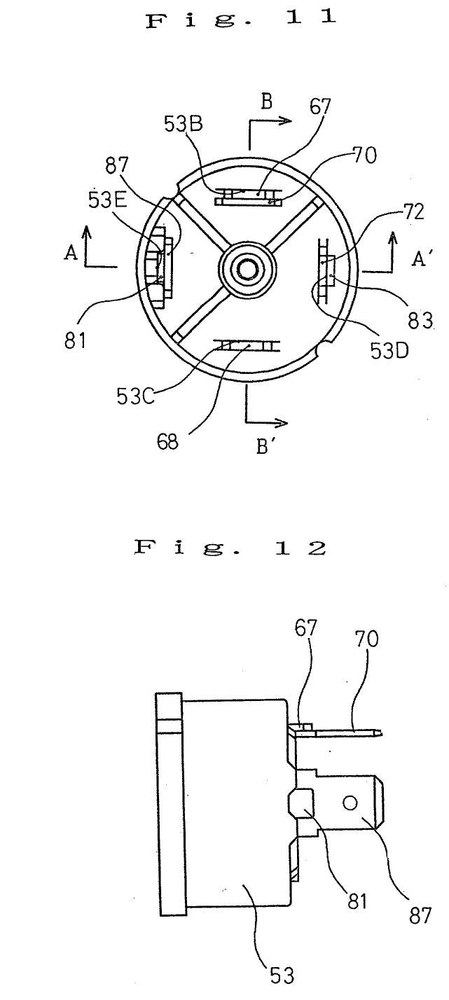

The second embodiment of a thermal protector of the present invention is described referring to FIG. 10 to FIG. 17. The thermal protector 51 of the second embodiment is attached on the protected outer surface 57 as shown in FIG. 17. As shown in FIG. 10A, the enclosure 52 made of insulator comprises a cylinder case 53 having one open end and a cover for covering the open end. The cover comprises a thermo base 54 of the thermostat section 80 and a cap 56.

The protector section 60 is incorporated in the internal of the case 53, thereafter, the thermostat section 80 which is normally closed and abnormally open at a prescribed temperature is fitted with interposition of a flexible paper 55 made of insulator. Further, adhesive 58 is filled to cover the live part which is exposed outside (a portion of the movable side terminal 83 described hereinafter), and the cap 56 is fixed.

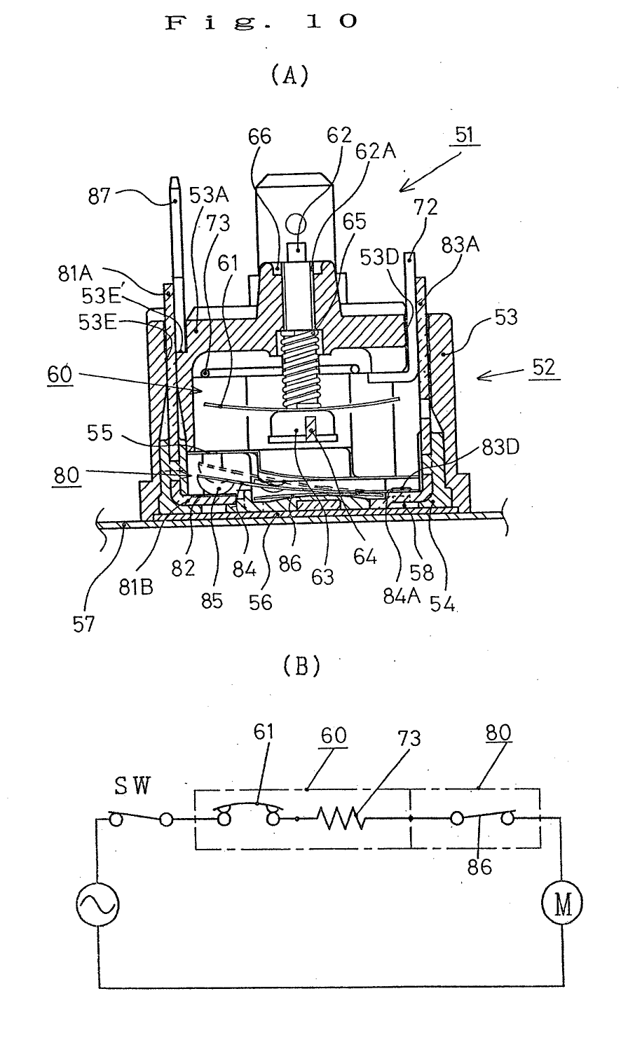

Next, the structure of the protector section 60 is described referring to FIG. 13. In the protector section 60, an adjusting screw 62 is provided at the center of the bottom 53A on the non-open end of the cylinder case 53. The adjusting spring 65 presses and holds the dished main bimetal 61 onto the head 63 of the adjusting screw 62. The adjusting screw 62 comprises a screw section 62A and a head 63, both are fixed with thermally melt-able metal 64, and the adjusting screw 62 is fixed with locking adhesive 66 after completion of the adjusting. The legs of the fixed terminal plates 67 and 68 having inlay type fixed contacts 69 and 69 are inserted into the slots 53B and 53C of the bottom 53A of the case 53 as shown in FIG. 11, and both sides are crimped to secure. The tab terminal 70 for connecting a lead wire (not shown in the figure) from the power source is fixed to the one outer end of the fixed terminal plate 67 by spot welding. The movable contacts 71 and 71 provided on the main bimetal 61 are facing respectively to the fixed contacts 69 and 69 for open-close operation. The heater terminal plate 72 is secured in the slot 53D provided at the position distant from 90 degrees from the center of the bottom 53A of the case 53 like the above-mentioned fixed terminal plates 67 and 68 as shown in FIG. 11. The heater 73 made of nichrome wire is disposed facing to and near the main bimetal 61 so as to heat the main bimetal 61, and both ends of the heater 73 are connected to the other fixed terminal plate 68 and heater terminal plate 72 by spot welding.

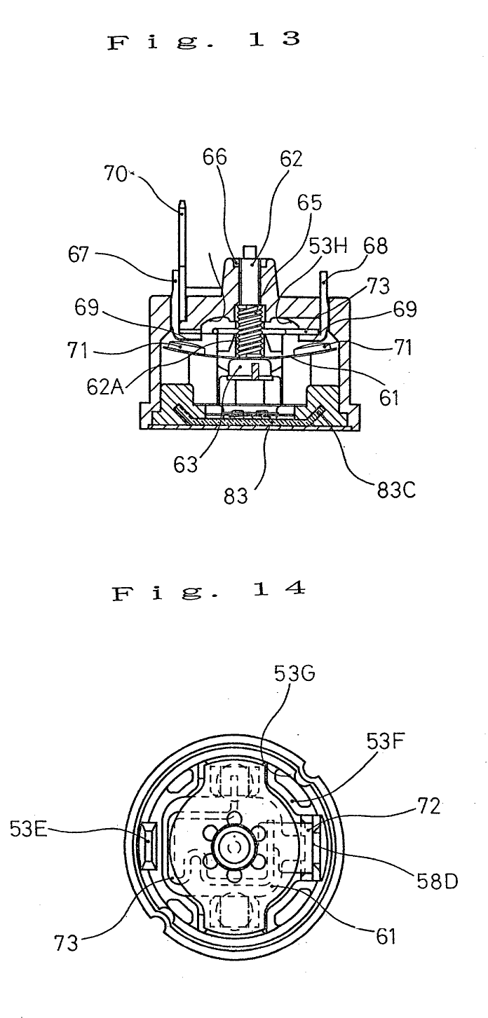

FIG. 14 is a bottom view of the protector section 60 incorporated in the case 53. As shown in the figure, the outer wall of the case 53 near the side of the main bimetal 61 comprises the inside wall 53F along the side end of the main bimetal 61 and the side wall 53G of the outer circular periphery to form a double wall, and the space between the walls (sealed with the insulating paper 55 and thermo base 54 as described hereinafter) results in an air accumulated space which serves as an air insulating layer, the air space serves the insulating function between the inside protector section and the external. To concentrate effectively the heat generated from the heater 73 on the main bimetal 61, the case 53 for containing the protector section is formed of white material which is excellent in reflection of heat radiation, or is formed of usual material and is coated with heat reflective material on the inside surface, or is formed in a concave mirror shape 53H, and thus the duty ratio is shortened when the current increases.

In the protector section 60, normally a current is supplied from the tab terminal 70 fixed to the one fixed terminal plate 67 and outputted to the heater terminal plate 72 through the fixed terminal plate 67, fixed contact 69, movable contact 71, main bimetal 61, movable contact 71, fixed contact 69, the other fixed terminal plate 68 and heater 73.

Next, the structure of the thermostat section 80 is described referring to FIG. 10A and FIG. 11. The thermostat section 80 comprises a fixed side terminal 81 having an inlay type fixed contact 82 at the bent part 81B, a movable side terminal 83, a movable contact plate 84 having a thermo movable contact 85 at the free end, and a thermo bimetal 86. The fixed side terminal 81 and movable side terminal 83 are insert-formed with the thermo base 54 which serves also as a cover for covering the open end of the cylinder case 53 together with the cap 56, the extensions of both terminals 81A and 83A are served as the terminal.

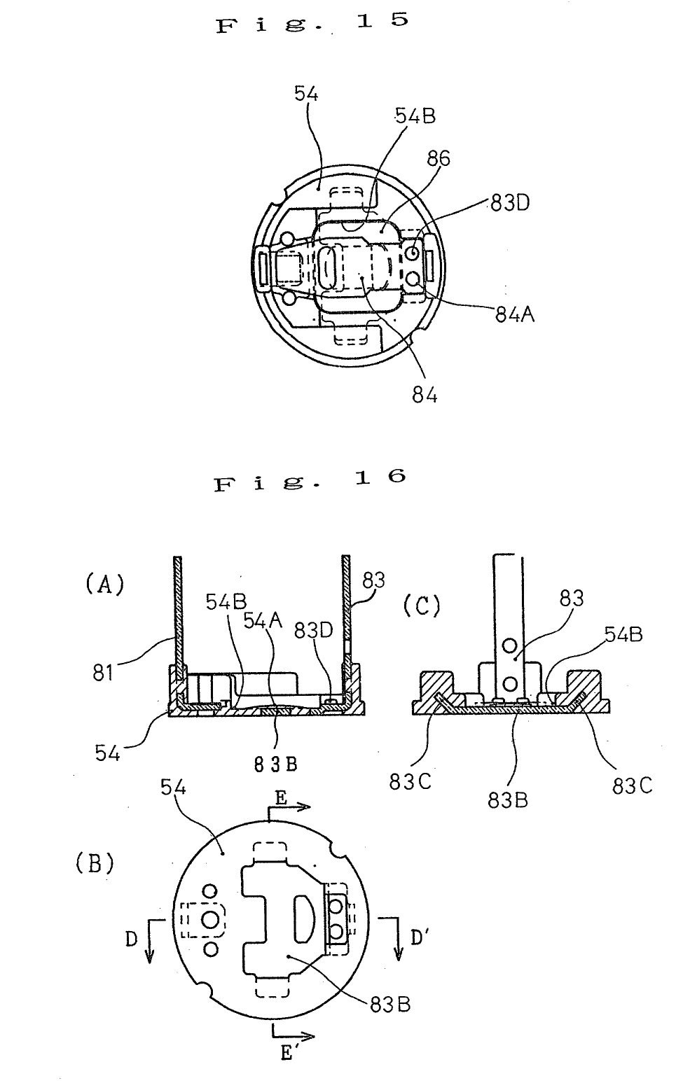

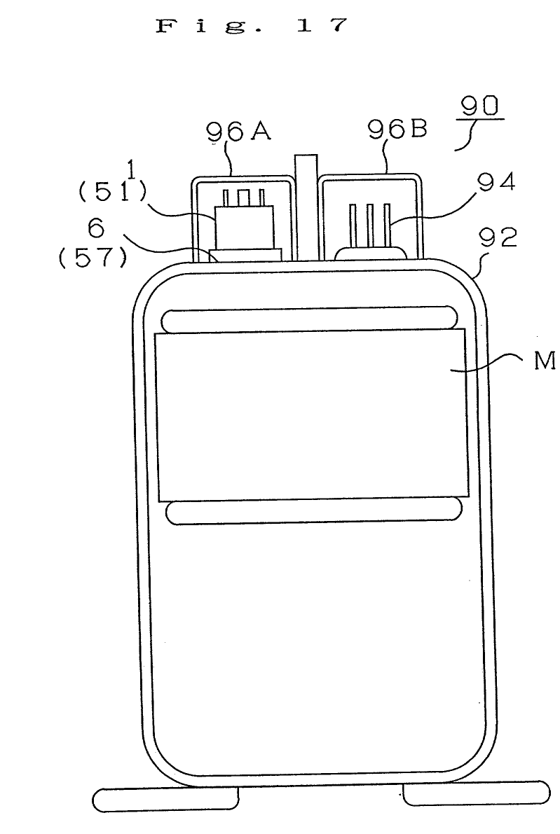

As shown in FIG. 16, the movable side terminal 83 can transfer effectively the heat from the protected surface to the thermo bimetal 86 through the fan-shaped wide part 83B with a cut-off having nails 83C on both sides thereof, and is inserted into the prescribed position of the thermo base 54 (cover). As shown in FIG. 16A, the convex part 54A having a circular arc cross-section is upward convex in the FIG. toward the intermediate of the wide part 83B. As shown in FIG. 15, the movable contact plate 84 made of elastic metal plate, the small projections 83D of the movable side terminal are inserted into the small holes 84A of the base end, and crimped to fix, and the thermo movable contact 85 of the free end is brought in on-off contact with the fixed contact 82. The thermo bimetal 86 is inserted into between the movable contact plate 84 and the circular arc convex part 54A on the center of the cover 54, and normally is upward convex as shown in FIG. 10A, the movable contact plate 84 presses the thermo movable contact 85 at the end thereof onto the facing thermo fixed contact 82 with elastic force thereof. When the temperature rises to a prescribed temperature, the thermo bimetal 86 is reversed to change the upward convex shape to the downward convex shape, the contacts 82 and 85 are opened rapidly to shut down the circuit.

As shown in FIG. 16A, the extensions 81A and 83A of the fixed side terminal 81 and movable side terminal 83 of the thermostat section 80 incorporated on the thermo base 54 to form a solid piece is inserted into the slots 53D and 53E provided at the position (on the line A-A′) orthogonal to the center line B-B′ of the fixed terminal plates 67 and 68 of the protector section 60 on the bottom 53A, of the cylinder case 53 shown in FIG. 11. The heater terminal plate 72 of the protector section secured already in the slot 53D and the movable side terminal 83 are fixed by spot welding. The tab terminal 87 which is added from the external and positioned by the step 53E′ is fixed to the extension 81A of the fixed side terminal 81 inserted in the slot 53E similarly to serve as the output terminal to the protected motor. Thereby the thermostat section 80 is fixed to the case 53. The protector section 60 and the thermostat section 80 are hooking-up connected in the slot 53D. As described herein above, if the tab terminal 70 of the protector section 60 is served as the input side terminal of power source, then the tab terminal 87 of the thermostat section 80 is served as the output terminal to the load motor. The thermal protector 51 of the second embodiment is provided in the same phase of the power source like the first embodiment, if the input side and output side are reversed, the thermal protector can be used without any trouble.

The thermo bimetal 86, which was formed in an approximately square rectangular shape and was subjected to forming, and which is operated in changing between convex and concave at a prescribed temperature, is guided and held by the inner convex part 54B of the thermo base 54 (refer to FIG.16A), and is inserted between the center of the circular arc projection part 54A of the thermo base 54 and the movable contact plate 84. That is, the left end (in FIG. 10) of the thermo bimetal 86 is lifted to pushup the movable contact plate 84 utilizing the principle of the lever having the base end at the right end (in FIG. 10) and having the fulcrum at the circular arc projection 54A of the cover 54, the contacts 85 and 82 are separated to shut down the circuit. The circular arc convex part 54A and the thermo bimetal 86 are positioned on the center line A-A′, in other words, the right end of the bimetal 86 is supported loosely and the left end is movable without restriction, therefore the movement of the end of the movable contact plate 84 driven by the movement of the bimetal 86 and the movement of the thermo movable contact 85 are large and rapid, and thus this movement ensures the smooth and reliable switching.

In the thermal protector 51 of the second embodiment, if an excess current is caused due to overload or locked rotot on the motor M, the main bimetal 61 generates heat, the dish is reversed to shut down the current, and the motor M is protected.

On the other hand, if only the temperature rises without current increase, the thermo bimetal 86 of the upward convex shape in the normal temperature (shown in FIG. 10A with a solid line) is reversed to the downward convex shape rapidly to push up the movable contact plate 84, and the contacts 85 and 82 are opened (shown in FIG. 10A with a broken line).

Next, a modified example of the second embodiment is described. This modified embodiment has the same structure as that of the above-mentioned second embodiment excepting that a copper or aluminum plate which is excellent in thermal conductance is inserted to the thermo base 54 of the thermostat section 60 and the fan-shaped part is removed from the movable side terminal 83. Alternately, in the above-mentioned embodiment, the cap 56 is formed of copper-clad laminate and the face of the cap 56 is fitted on the surface of the protected body to improve the thermal conductivity from the protected body.

As described hereinabove, in the thermal protector 51 of the second embodiment, the cover to which the thermostat section is provided is fitted on the surface of the protected body, the cover is made at least partially of a material having excellent thermal conductivity to improve the thermal conduction to the thermostat section, and the temperature rising of the internal motor, which is the heat source, is detected rapidly, therefore the thermal protector can respond sensitively.

Next, in the protector section, the heat generated from the heater is reflected by the reflective material on the inside surface of the case or reflected by the concave mirror function of the inside surface to concentrate the heat radiation on the main bimetal, the main bimetal is heated rapidly to trip the operation. Afterwards, the accumulated heat energy is prevented from being dissipated to the outside by the insulation function of air between the double wall, the temperature around the bimetal is maintained at high temperature for long time, and thus the reset time is extended long and the duty ratio is made small.

What is claimed is:

1. A thermal protector comprising an enclosure provided with a cylinder case having one open end and a cover for closing said open end and for fitting on the surface of a protected body, a protector section in which the main bimetal is connected in series to a heater wire provided near the main bimetal, and a thermostat section being normally closed and being occasionally opened when the temperature rises to a prescribed temperature, and said protector section and the thermostat section being disposed on the bottom side of the cylinder case and on the cover side in the enclosure respectively, and the protector section and the thermostat section being connected in series.

2. The thermal protector according to claim 1, wherein said protector section is provided with two fixed terminal plates having a fixed contact respectively and secured on the bottom of the said cylinder case, an adjusting screw provided on the bottom of said cylinder case, and movable contacts facing to the fixed contacts for switching, and comprises the main bimetal pressed and supported onto the head of the adjusting screw by a spring, and a heater wire connected between said one fixed terminal plate provided near said main bimetal and the heater terminal.

3. The thermal protector according to claim 1 or claim 2, wherein the bimetal of the thermostat section is disposed at the position which is parallel to the surface of the protected body and nearest to the said cover.

4. The thermal protector according to claim 1, claim 2, or claim 3, wherein the adjusting screw of the protector section comprises the head and screw section bonded with thermally melt-able metal.

5. A method for assembling a thermal protector, in which thermal protector comprising an enclosure provided with a cylinder case having one open end and a cover for closing said open end and for fitting on the surface of a protected body, a protector section in which the main bimetal is connected in series to a heater wire provided near the main bimetal, and a thermostat section being normally closed and being occasionally opened when the temperature rises to a prescribed temperature, and said protector section and the thermostat section being disposed on the bottom side of the cylinder case and on the cover side in the enclosure respectively, and the protector section and the thermostat section being connected in series, said thermal protector further comprising the step of incorporating and adjusting the thermostat section after incorporating and adjusting said protector section in said cylinder case.

6. A thermal protector comprising;
a cylinder case with an open end,
a cover for closing said open end and for fitting on the surface of a protected body,
a protected section provided with a pair of fixed terminal plates having a fixed contact secured on the bottom of said case, a main bimetal having a movable contact for open-close contact operation with the said fixed contact supported by said case, and a heater wire being connected between the one fixed terminal plate and the heater terminal plate and disposed near said main bimetal, and
a thermostat section provided with a pair of terminal plates being normally closed and being occasionally opened when the temperature rises to a prescribed temperature,
said thermal protector further comprising; said pair of fixed terminal plates of said protector section and said pair of terminal plates of said thermostat section being guided to the outside from the bottom of said case, and disposed at the position orthogonal each other, and
said heater terminal plate of said protector section being connected to the one terminal plate of said thermostat section outside to connect said protector section and said thermostat section in series.

7. The thermal protector according to claim 6, wherein said heater terminal plate of said protector section is connected to the one terminal plate of said thermostat section by spot welding.

8. A thermal protector comprising an enclosure provided with a cylinder case having one open end and a cover for closing said open end and for fitting on the surface of a protected body, a protector section having the main bimetal and a heater wire provided near the main bimetal, and a thermostat section being normally closed and being occasionally opened when the temperature rises to a prescribed temperature, and said protector section and the thermostat section being connected in series, said thermal protector further comprising said protector section and the thermostat section being insulated with insulating material.

9. A thermal protector comprising an enclosure provided with a cylinder case having one open end and a cover for closing said open end and for fitting on the surface of a protected body, a protector section having the main bimetal and a heater wire provided near the main bimetal, and a thermostat section being normally closed and being occasionally opened when the temperature rises to a prescribed temperature, and said protector section and the thermostat section being connected in series, said thermal protector further comprising the step of forming the case in which the protector section is contained with heat reflective material to concentrate the heat generated from the heater on the main bimetal for absorbing the heat.

10. A thermal protector comprising an enclosure provided with a cylinder case having one open end and a cover for closing said open end and for fitting on the surface of a protected body, a protector section having the main bimetal and a heater wire provided near the main bimetal, and a thermostat section being normally closed and being occasionally opened when the temperature rises to a prescribed temperature, and said protector section and the thermostat section being connected in series, said thermal protector further comprising the step of forming the inside surface of the case to which the protector section is provided at least partially in the form of a concave mirror to concentrate the heat generated from the heater on the main bimetal for absorbing the heat.

11. A thermal protector comprising an enclosure provided with a cylinder case having one open end and a cover for closing said open end and for fitting on the surface of a protected body, a protector section having the main bimetal and a heater wire provided near the main bimetal, and a thermostat section being normally closed and being occasionally opened when the temperature rises to a prescribed temperature, and said protector section and the thermostat section being connected in series, said thermal protector further comprising the step of providing an air insulating layer at least partially on the wall of the case in which the protector section is provided.

12. A thermal protector comprising an enclosure provided with a cylinder case having one open end and a cover for closing said open end and for fitting on the surface of a protected body, a protector section having the main bimetal and a heater wire provided near the main bimetal, and a thermostat section being normally closed and being occasionally opened when the temperature rises to a prescribed temperature, and said protector section and the thermostat section being connected in series, said thermal protector further comprising the step of making the cover at least partially of heat conductive material to improve the heat conduction between the thermostat section and the surface of the protected body.

13. The thermal protector according to claim 8, wherein the adjusting screw comprises the screw section and head, and the screw section and head are bonded with thermally meltable metal.

14. A compressor having the thermal protector according to claim 1.

15. A compressor having the thermal protector according to claim 2.

16. A compressor having the thermal protector according to claim 3.

17. A compressor having the thermal protector according to claim 4.

18. A compressor having the thermal protector according to claim 6.

19. A compressor having the thermal protector according to claim 7.

20. A compressor having the thermal protector according to claim 8.

21. A compressor having the thermal protector according to claim 9.

22. A compressor having the thermal protector according to claim 10.

23. A compressor having the thermal protector according to claim 11.

24. A compressor having the thermal protector according to claim 12.

25. A compressor having the thermal protector according to claim 13.
